(19) United States
(12) Patent Application Publication
(10) Pub. No.: US 2025/0202308 A1
(43) Pub. Date: Jun. 19, 2025

(54) ELECTRIC MACHINE HAVING A FASTENING CLIP FOR THERMALLY COUPLING A TEMPERATURE SENSOR TO A STATOR WINDING

(71) Applicant: Valeo eAutomotive Germany GmbH, Erlangen (DE)

(72) Inventor: Mert CIFTCIOGLU, Bad Neustadt an der Saale (DE)

(73) Assignee: Valeo eAutomotive Germany GmbH, Erlangen (DE)

(21) Appl. No.: 18/984,032

(22) Filed: Dec. 17, 2024

(30) Foreign Application Priority Data
Dec. 18, 2023 (DE) 102023135673.9

(51) Int. Cl. H02K 3/50; H02K 1/16; H02K 11/00; H02K 11/25; H02K 15/40

(52) U.S. Cl. CPC H02K 3/50; H02K 1/16; H02K 11/0094; H02K 11/25; H02K 15/40

(57) ABSTRACT

An electric machine includes a stator, which has a stator laminated core and a stator winding arranged in the stator laminated core. In addition, the electric machine includes a temperature sensor, which is thermally conductively coupled to the stator winding and is configured to measure a temperature of the stator winding. The thermally conductive coupling is created by a fastening clip with a latching connection, wherein the fastening clip presses the temperature sensor against the stator winding or a heat-conducting element thermally conductively connected to the stator winding. The invention furthermore specifies a vehicle having such an electric machine, and also a method for producing a thermally conductive coupling between a temperature sensor and a stator winding or a heat-conducting element of an electric machine, the heat-conducting element being thermally conductively connected to the stator winding.

### TECHNICAL FIELD

The invention relates to an electric machine comprising a stator, which has a stator laminated core with a plurality of stator laminations stacked axially one on the other and a stator winding arranged in the stator laminated core. Furthermore, the electric machine comprises a temperature sensor, which is thermally conductively coupled to the stator winding and is configured to measure a temperature of the stator winding. The invention furthermore relates to a vehicle having such an electric machine, and also to a method for producing a thermally conductive coupling between a temperature sensor and a stator winding or a heat-conducting element of an electric machine, the heat-conducting element being thermally conductively connected to a stator winding.

### PRIOR ART

Such an electric machine, such a vehicle and such a method are known in principle from the prior art. The problem here is that the known solutions for producing a thermally conductive coupling between a temperature sensor and a stator winding of an electric machine are sometimes cumbersome, difficult to reproduce and/or difficult to maintain. For example, it is known to adhesively bond a temperature sensor to the stator winding using a thermally conductive adhesive. The problems here are, in particular, correct application of the adhesive, which should not reach other points of the electric machine in an uncontrolled manner, and also fixing of the temperature sensor until the adhesive has cured. These processes cannot be reproduced or can be reproduced only with a high level of technical effort within tight tolerance limits. It also takes a comparatively long time to mount the temperature sensor on the stator winding. Finally, the temperature sensor also cannot be easily replaced should it fail. In particular, there is a high risk of the insulation of the stator winding being damaged here.

### DISCLOSURE OF THE INVENTION

An object of the invention is therefore to specify an improved electric machine, an improved vehicle and an improved method for producing a thermally conductive coupling between a temperature sensor and a stator winding of an electric machine. In particular, a thermally conductive coupling between a temperature sensor and a stator winding of an electric machine should be able to be established quickly and with process reliability. In addition, it should also be possible to easily replace the temperature sensor, in particular without damaging an insulation of the stator winding.

The object of the invention is achieved by an electric machine of the type mentioned at the outset, in which the thermally conductive coupling between the temperature sensor and the stator winding is created by a fastening clip with a latching connection and the fastening clip presses the temperature sensor against the stator winding or a heat-conducting element thermally conductively connected to the stator winding.

Furthermore, the object of the invention is achieved by a vehicle having such an electric machine, which is provided for driving the vehicle.

Finally, the object of the invention is achieved by a method for producing a thermally conductive coupling between a temperature sensor and a stator winding or a heat-conducting element of an electric machine (in particular an electric machine of the kind mentioned above), the heat-conducting element being thermally conductively connected to the stator winding, which method comprises the following steps:
arranging the temperature sensor and the stator winding or the heat-conducting element in a fastening clip and
producing the thermally conductive coupling between the temperature sensor and the stator winding or the heat-conducting element by closing the fastening clip, wherein a latching connection of the fastening clip latches in and wherein the fastening clip presses the temperature sensor against the stator winding or the heat-conducting element.

The proposed measures allow a thermally conductive coupling between a temperature sensor and a stator winding of the electric machine to be established quickly and with process reliability. It is advantageous if the fastening clip, after being closed, can be opened again without being destroyed, as a result of which the coupling between the temperature sensor and the stator windings can be released. This allows the temperature sensor to be easily replaced, without an insulation of the stator winding being damaged in the process. However, it is also conceivable that the fastening clip, after being closed, cannot be opened again without being destroyed and thus the thermal coupling between the temperature sensor and the stator winding cannot be released or cannot be released without being destroyed either, for example if this is not planned or necessary after commissioning the electric machine.

The term “thermally conductive coupling between the temperature sensor and a stator winding” means in particular that heat is exchanged between the stator winding and the temperature sensor by means of heat conduction, and, if at all, only to a negligible extent by radiation or convection. In particular, the proportion of heat transferred between the stator winding and the temperature sensor via heat conduction is more than 95% of the total amount of heat transferred between the stator winding and the temperature sensor. The term “thermally conductive connection” can also be used synonymously instead of “thermally conductive coupling”.

The temperature sensor can be connected directly to the stator winding. The thermally conductive connection is then “direct”. However, one or more heat-conducting elements, which implement the heat conduction, can also be arranged between the stator winding and the temperature sensor. The thermally conductive connection is then “indirect”.

The heat-conducting element can also be designed as a “busbar”. In particular when the heat-conducting element has a mechanically supporting function, this can also be interpreted as a “sensor carrier” and called such. An equivalent term for the “fastening clip” is, in particular, also “fastener clip”.

Further advantageous refinements and developments of the invention can be gathered from the dependent claims and from the description when considered together with the figures.

It is advantageous when ends of individual sections of the stator winding or ends of individual stator windings of the electric machine are electrically connected to a connector, which runs in the form of a ring or in the form of an arc around a stator axis of the stator, and
the heat-conducting element is formed by this connector or comprised by this connector.

For example, in this case, the stator winding can be constructed with “U-pins”, the free ends of which are electrically connected to the connector. However, the connector not only has an electrical function, but also acts as a heat-conducting element between the temperature sensor and the stator windings. The connector therefore has a dual function, and the thermally conductive connection between the stator windings and the temperature sensor is therefore “indirect” in this case. In particular, the connector can form an electrical star point of the electric machine.

It is particularly advantageous when the heat-conducting element has an extension to which the fastening clip is fastened. This allows the thermally conductive coupling between the temperature sensor and the heat-conducting element to be produced particularly easily. The connector can be formed in one piece with the extension. As an alternative, the extension can be fastened as a separate component on a base part of the connector. The extension preferably extends axially, but can also extend radially or both axially and radially.

It is furthermore particularly advantageous when a contact-pressure force generated by the fastening clip (in the closed state) lies in a range of from 10 N≤F≤40 N. This ensures good heat transfer to the temperature sensor even when vibrations occur during operation of the electric machine. In addition, the temperature sensor is not subjected to excessive mechanical loading here, and the fastening clip can be readily closed by hand. The specified contact-pressure force relates in particular to the new state of the fastening clip. Over time, this contact-pressure force can decrease due to settling and material creepage.

In a further advantageous design variant of the electric machine, the fastening clip has a raised portion, which projects into a recess in the stator winding or the heat-conducting element, or the fastening clip has a recess, into which a raised portion of the stator winding or the heat-conducting element projects. This can result in a better, for example axial, securing of the heat-conducting element in the fastening clip. For example, the recess in the stator winding or the heat-conducting element can be made with a chisel or centre punch. The region of a material upset created as a result is advantageously free from the fastening clip, in order to rule out any negative influence on a contact-pressure force.

It is expedient when the fastening clip has a guide for the heat-conducting element. This makes it easier to mount the fastening clip on the heat-conducting element. For example, the guide may comprise laterally arranged tabs or pins.

It is expedient when the temperature sensor is arranged loosely in a recess in the fastening clip, for example before the temperature sensor and fastening clip are fastened to a stator winding or a heat-conducting element. This allows the temperature sensor to be connected to the fastening clip particularly quickly. However, it is also expedient when the temperature sensor is fastened to the fastening clip. This prevents the temperature sensor from being unintentionally detached from the fastening clip during the mounting process.

It is also advantageous when a cable of the temperature sensor is guided through an opening in the fastening clip, wherein the opening is smaller than an extent of the temperature sensor or a heat-shrink tube mounted on the cable measured transversely to the longitudinal extent of the cable. This allows the temperature sensor to be secured particularly well in the fastening clip. Owing to its elasticity, a heat-shrink tube, which also sheaths at least a portion of the temperature sensor, can additionally strengthen a thermally conductive coupling between the temperature sensor and the stator winding or the heat-conducting element.

It is furthermore advantageous when an elastic element is arranged between the temperature sensor and the fastening clip and/or between the stator winding or the heat-conducting element and the fastening clip. For example, the elastic element can be made of silicone and can also be used to better compensate for manufacturing tolerances. The elastic element may be designed, in particular, such that it strengthens the thermally conductive coupling between the temperature sensor and the stator winding or the heat-conducting element.

In one embodiment, the fastening clip is constructed in multiple pieces. This may make it easier to mount the fastening clip under certain circumstances, for example when it has to be mounted in a hard-to-reach location.

In another embodiment, the fastening clip is constructed in one piece. This makes the fastening clip particularly cost-effective to produce. In addition, individual parts of the fastening clip then cannot be lost, this increasing process reliability when mounting the fastening clip.

Two parts of the fastening clip, the parts being pivotable in relation to each other, are optionally connected to each other via a joint. The joint may be formed, for example, by a thin plastic web.

It is expedient when the fastening clip contains plastic, in particular polyphenylene sulfide. This makes it easy to produce, for example by means of an injection-moulding process.

### BRIEF DESCRIPTION OF THE FIGURES

Exemplary embodiments of the invention are illustrated by way of example in the attached schematic figures. In the figures:

FIG. 1 shows an exemplary electric machine illustrated schematically in a half-section;

FIG. 2 shows an oblique view of an embodiment, illustrated in detail, of an exemplary stator;

FIG. 3 shows an oblique view of an exemplary fastening clip in the unmounted state;

FIG. 4 shows the fastening clip from FIG. 3 with a temperature sensor inserted;

FIG. 5 shows the fastening clip from FIGS. 3 and 4 with a heat-conducting element additionally inserted;

FIG. 6 shows the fastening clip from FIGS. 3 to 5 in the closed state;

FIG. 7 shows a side view of the fastening clip from FIG. 5, and

FIG. 8 shows an exemplary vehicle having an electric machine of the proposed type.

### DETAILED DESCRIPTION OF THE INVENTION

It is stated, by way of introduction, that identical parts in the different embodiments are provided with the same reference signs or the same component designations, with different indices where appropriate. The disclosure, in the description, of a component may accordingly be transferred to another component with the same reference sign or the same component designation. Also, the positional terms selected in the description, such as “top”, “bottom”, “rear”, “front”, “side” etc., relate to the figure directly described and illustrated, and, in the event of a change in position, should be transferred accordingly to the new position.

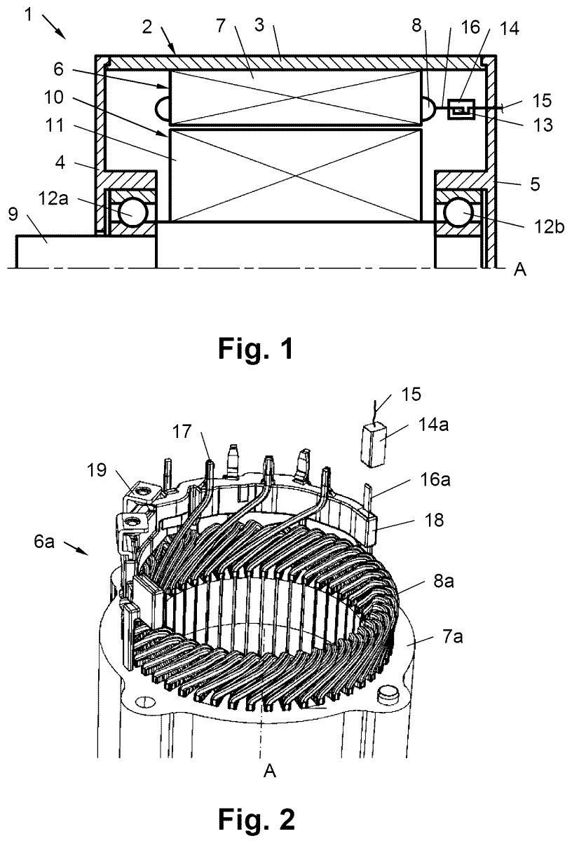

FIG. 1 shows a half-section through a schematically illustrated electric machine 1 having a multiple-piece machine housing 2, which comprises a stator housing 3, a front end plate 4 and a rear end plate 5. In addition, the electric machine 1 has a stator 6, which has a stator laminated core 7, not shown in detail, and also a stator winding 8 arranged in the stator laminated core 7. Furthermore, the electric machine 1 comprises a rotor shaft 9 with a rotor 10 seated on the rotor shaft, the rotor having a rotor laminated core 11, not shown in detail, and rotor magnets or rotor windings (not shown) arranged in the rotor laminated core. The rotor shaft 9 is mounted by means of (roller) bearings 12a, 12b so as to be rotatable about a rotor axis or stator axis A in relation to the stator 6. Specifically, the first bearing 12a is seated in the front end plate 4, and the second bearing 12b is seated in the rear end plate 5.

Furthermore, the electric machine 1 comprises a temperature sensor 13, which is arranged in a fastening clip 14 and which is connected to a (sensor) cable 15, which is guided through the machine housing 2. The temperature sensor 13 is thermally conductively coupled to the stator winding 8 and is configured to measure a temperature of the stator winding 8. For this purpose, the electric machine 1 has a heat-conducting element 16 thermally conductively connected to the stator winding 8 and guided into the fastening clip 14. The fastening clip 14 pushes the temperature sensor 13 against the heat-conducting element 16 in the closed state and in this way creates the thermally conductive coupling between the temperature sensor 13 and the stator winding 8. The fastening clip 14 has a latching connection, by means of which the fastening clip 14 is kept closed.

It would also be conceivable that the fastening clip 14 can be mounted directly onto the stator winding 8, as a result of which the thermally conductive coupling between the temperature sensor 13 and the stator winding 8 can likewise be produced. A separate heat-conducting element 16 can then be dispensed with.

At this point, it is noted that the machine housing 2 can also be constructed differently and can comprise more or fewer parts than shown in FIG. 1. For example, the stator housing 3 could be pot-shaped and the front end plate 4 could be dispensed with. Accordingly, the first housing part 3 and the second housing part 5 may also be shaped differently.

FIG. 2 now shows an oblique view of an embodiment, illustrated in somewhat more detail, of a stator 6a. The stator 6a in turn has a stator laminated core 7a and a stator winding 8a arranged in the stator laminated core. In this case, ends 17 of individual sections of the stator winding 8a are electrically connected to a connector 18, wherein the connector 18 runs in the form of a ring or in the form of an arc around the stator axis A of the stator 6a. For example, the stator winding 8a may be constructed with “U-pins” in this case. A heat-conducting element or extension 16a, against which the temperature sensor 13 bears, is connected to the connector 18 or is comprised by the connector.

In FIG. 2, the temperature sensor 13 is covered by the fastening clip 14a, which is additionally not yet mounted on the extension 16a in FIG. 2. Both the connector 18 and its extension 16a are thermally conductive intermediate parts in this case. The thermally conductive connection between the stator winding 8a and the temperature sensor 13 is therefore “indirect” in this case. In addition, FIG. 2 also shows connections 19, by way of which the stator winding 8a can be electrically connected to connection cables of the electric machine 1 (not shown). In particular, the connector 18 can form an electrical star point of the electric machine 1.

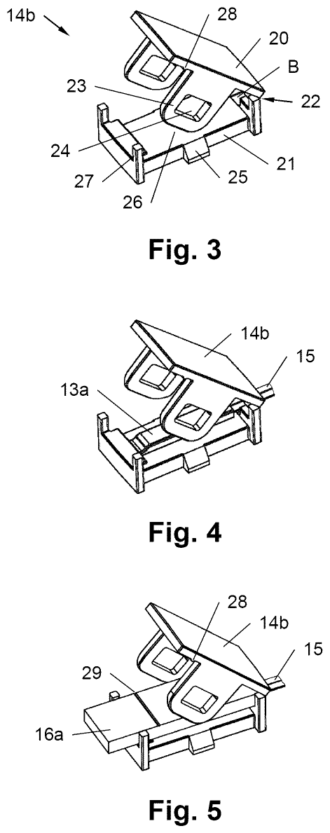

FIGS. 3 to 7 then show an example of a fastening clip 14b in different states and in different views.

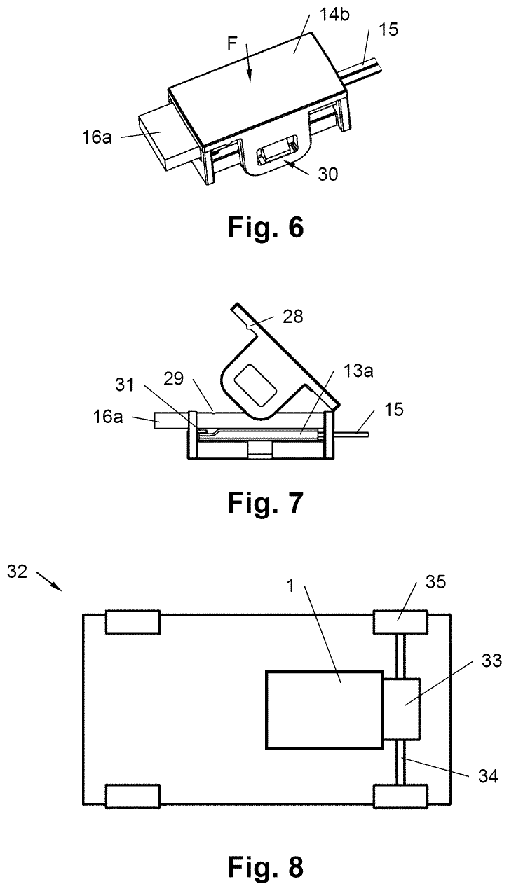

FIG. 3 shows an oblique view of the fastening clip 14b in the non-mounted state, FIG. 4 with the temperature sensor 13a inserted, FIG. 5 with the heat-conducting element 16a additionally inserted, FIG. 6 in closed state, and FIG. 7 shows a side view in the open state.

In this exemplary embodiment, the fastening clip 14b is constructed in one piece and has an upper part 20 and a lower part 21, which are connected to each other via a joint 22 and are therefore pivotable in relation to each other. In this example, the fastening clip 14b is constructed from a plastic (in particular from polyphenylene sulfide), wherein the joint 22 is formed by a narrow plastic web. However, the joint 22 could also be constructed differently. Furthermore, the fastening clip 14b could also be made of a different material.

The fastening clip 14b has two side tabs 23, each with recesses 24 arranged therein, on its upper part 20. Two latching lugs 25 are arranged on the lower part, which latching lugs interact with the side tabs 23 or with the recesses 24 in the closed state of the fastening clip 14b (see in particular FIG. 6 in this respect). The lower part 21 additionally comprises a support surface 26 for the temperature sensor 13a and a guide 27 for the heat-conducting element 16b. A downwardly directed raised portion 28 is additionally provided on the upper part 20. Finally, an opening B for the cable 15 is located in the rear part of the fastening clip 14b.

In FIG. 4, the temperature sensor 13a is already inserted into the fastening clip 14b and rests on the support surface 26. The cable 15 is guided through the opening B. The temperature sensor 13a can rest loosely on the support surface 26 or be attached, for example adhesively bonded, to the support surface. It would also be conceivable that the temperature sensor 13a is arranged in a recess in the fastening clip 14b and in particular is fastened in this recess.

In FIG. 5, the heat-conducting element 16a is additionally inserted into the fastening clip 14b. Specifically, the heat-conducting element rests on the temperature sensor 13a and is laterally fixed by the guide 27. The heat-conducting element 16a has a recess 29, into which the raised portion 28 protrudes in the closed state of the fastening clip 14b and axially secures the heat-conducting element 16a against slipping out of the fastening clip 14b.

For example, the recess 29 in the heat-conducting element 16a can be made using a chisel or centre punch. The region of a material upset created as a result is advantageously free from the fastening clip 14b, in order to rule out any negative influence on a contact-pressure force. Specifically, the raised portion 28 is arranged outside the region of the side tabs 23 in this example. It would also be conceivable for axial securing of the heat-conducting element 16a that the fastening clip 14b has a recess, into which a raised portion of the heat-conducting element 16a protrudes. It is, of course, also conceivable that the raised portion 28 and the recess 29 are arranged in a different location to that shown.

The temperature sensor 13a can be axially secured by way of the opening B being smaller than an extent of the temperature sensor 13a measured transversely to the longitudinal extent of the cable 15, as is shown in particular in FIG. 4. It would furthermore be conceivable that the temperature sensor 13a is axially secured by a heat-shrink tube mounted on the temperature sensor 13a and/or on the cable 15, the extent of the heat-shrink tube measured transversely to the longitudinal extent of the cable 15 being greater than the opening B.

Owing to the latching connection 30, which is formed by the latching lugs 25 and the side tabs 23 in this example, and also owing to the elasticity of the material selected for the fastening clip 14b and a deformation present in the closed state of the fastening clip 14b, a contact-pressure force F generated by the fastening clip 14b is produced, this contact-pressure force pushing the temperature sensor 13a against the heat-conducting element 16a and thus creating the thermally conductive coupling between the temperature sensor 13a and the stator winding 8, 8a. The contact-pressure force F generated by the fastening clip 14b advantageously lies in a range of from 10 N≤F≤40 N. This ensures good heat transfer to the temperature sensor 13a even when vibrations occur during operation of the electric machine 1. In addition, the temperature sensor 13a is not subjected to excessive loading here, and the fastening clip 14b can be readily closed by hand. The specified contact-pressure force F relates in particular to the new state of the fastening clip 14b. Over time, this contact-pressure force F can decrease due to settling and material creepage.

It is furthermore conceivable that an elastic element is arranged between the temperature sensor 13a and the fastening clip 14b and/or between the heat-conducting element 16a and the fastening clip 14b (not shown) and optionally strengthens the thermally conductive coupling between the temperature sensor 13a and the heat-conducting element 16a. For example, the elastic element can be made of silicone and can be used to better compensate for manufacturing tolerances. A heat-shrink tube, which sheaths at least a portion of the temperature sensor 13a, can, on account of its elasticity, also strengthen a thermally conductive coupling between the temperature sensor 13a and the heat-conducting element 16a and accordingly also assume the function of such an elastic element.

FIG. 7 additionally also shows a retaining tongue 31, which secures the temperature sensor 13a against falling out at least at one end, this being advantageous particularly when the temperature sensor 13a is merely loosely inserted into the fastening clip 14b. In particular, in connection with the retaining action of the cable 15 guided through the opening B and any axial securing, for example by a heat-shrink tube, relatively secure fixing of the temperature sensor 13a in the fastening clip 14b is produced, so that this fastening clip can be attached with process reliability.

In the examples shown, the fastening clip 14, 14a, 14b was attached in the region of a (separate) heat-conducting element 16, 16a. However, as an alternative, it would also be conceivable that the fastening clip 14, 14a, 14b is mounted directly on the stator winding 8, 8a. For example, the stator winding 8, 8a can then be guided through a larger opening B. A heat-conducting element 16, 16a can be dispensed with when the fastening clip 14, 14a, 14b is mounted onto the stator winding 8, 8a.

It is also conceivable that the fastening clip 14b is not constructed in one piece, as shown in FIGS. 3 to 7, but rather is constructed in two pieces. The joint 22 can then be dispensed with, and the upper part 21 and the lower part 21 are then present as separate components. Mounting is thus simplified under certain circumstances, in particular when a stator winding 8, 8a is to be guided through the fastening clip 14b.

In summary, a method for producing a thermally conductive coupling between a temperature sensor 13, 13a and a stator winding 8, 8a or a heat-conducting element 16, 16a of an electric machine 1, the heat-conducting element being thermally conductively connected to the stator winding, may comprise the following steps:
arranging the temperature sensor 13, 13a and the stator winding 8, 8a or the heat-conducting element 16, 16a in a fastening clip 14, 14a, 14b and
producing the thermally conductive coupling between the temperature sensor 13, 13a and the stator winding 8, 8a or the heat-conducting element 16, 16a by closing the fastening clip 14, 14a, 14b, wherein a latching connection 30 of the fastening clip 14, 14a, 14b latches in and wherein the fastening clip 14, 14a, 14b presses the temperature sensor 13, 13a against the stator winding 8, 8a or the heat-conducting element 16, 16a.

The fastening clip 14, 14a, 14b can generally be releasable or non-releasable. The fastening clip 14b shown in FIGS. 3 to 7 is releasable-provided that the material of the fastening clip 14b is sufficiently elastic. For releasing purposes, the side tabs 23 are somewhat bent to the side in order to cancel the latching connection 30. This makes it possible to easily replace the temperature sensor 13a. However, it is also conceivable that, by corresponding design of the latching connection 30, the fastening clip 14, 14a, 14b, after being closed, cannot be opened again without being destroyed and thus the thermal coupling between the temperature sensor 13a and the stator winding 8, 8a cannot be released or cannot be released without being destroyed either, for example if this is not planned or necessary after commissioning the electric machine 1.

FIG. 8 finally shows the electric machine 1 installed into a vehicle 32. The vehicle 32 has two axles, one of which is driven. Specifically, the electric machine 1 is connected to the half-axles 34 of the rear axle via an optional gearbox 33. Finally, the driven wheels 35 are mounted on the half-axles 34. The vehicle 32 is at least partially or temporarily driven by the electric machine 1. This means that the electric machine 1 may be used as the sole drive of the vehicle 32 or may be provided, for example, in conjunction with an internal combustion engine (hybrid drive).

In conclusion, it is emphasized that the scope of protection is determined by the claims. The description and the drawings should, however, be used to interpret the claims. The features contained in the figures can be interchanged and combined with one another as desired. In particular, it is also emphasized that the devices illustrated may in reality comprise even more or even fewer component parts than illustrated. In some cases, the illustrated devices or their component parts may also be illustrated not to scale and/or on an enlarged scale and/or on a reduced scale.

### LIST OF REFERENCE SIGNS

1 Electric machine
2 Machine housing
3 Stator housing
4 Front end plate
5 Rear end plate
6, 6a Stator
7, 7a Stator laminated core
8, 8a Stator winding
9 Rotor shaft
10 Rotor
11 Rotor laminated core
12a, 12b (Roller) bearings
13, 13a Temperature sensor
14, 14a, 14b Fastening clip
15 (Sensor) cable
16, 16a Heat-conducting element/extension
17 End of stator winding section
18 Connector
19 Stator winding connection
20 Fastening clip upper part
21 Fastening clip lower part
22 Joint
23 Side tab
24 Side tab recess
25 Latching lug
26 Support surface for temperature sensor
27 Guide for heat-conducting element
28 Fastening clip raised portion
29 Heat-conducting element recess
30 Latching connection
31 Retaining tongue
32 Vehicle
33 Gearbox
34 Half-axle
35 Wheel
A Stator axis/rotor axis
B Opening for (sensor) cable
F Contact-pressure force

1. Electric machine, comprising
a stator, which has a stator laminated core with a plurality of stator laminations stacked axially one on the other and a stator winding arranged in the stator laminated core,
a temperature sensor, which is thermally conductively coupled to the stator winding and is configured to measure a temperature of the stator winding,
wherein
the thermally conductive coupling between the temperature sensor and the stator winding is created by a fastening clip with a latching connection and the fastening clip presses the temperature sensor against the stator winding or a heat-conducting element thermally conductively connected to the stator winding.

2. Electric machine according to claim 1, wherein
ends of individual sections of the stator winding are electrically connected to a connector, which runs in the form of a ring or in the form of an arc around a stator axis of the stator, and
the heat-conducting element is formed by this connector or comprised by this connector.

3. Electric machine according to claim 2, wherein the heat-conducting element has an extension to which the fastening clip is fastened.

4. Electric machine according to claim 1, wherein a contact-pressure force generated by the fastening clip lies in a range of from 10 N≤F≤40 N.

5. Electric machine according to claim 1, wherein the fastening clip has a raised portion, which projects into a recess in the stator winding or the heat-conducting element, or the fastening clip has a recess, into which a raised portion of the stator winding or the heat-conducting element projects.

6. Electric machine according to claim 1, wherein the fastening clip has a guide for the heat-conducting element.

7. Electric machine according to claim 1, wherein the temperature sensor is loosely arranged in a recess in the fastening clip or b) is fastened to the fastening clip.

8. Electric machine according to claim 1, wherein a cable of the temperature sensor is guided through an opening in the fastening clip, wherein the opening is smaller than an extent of the temperature sensor or a heat-shrink tube mounted on the cable measured transversely to the longitudinal extent of the cable.

9. Electric machine according to claim 1, wherein an elastic element is arranged
between the temperature sensor and the fastening clip and/or
between the stator winding or the heat-conducting element and the fastening clip.

10. Electric machine according to claim 1, wherein the fastening clip is constructed i) in multiple pieces or ii) in one piece.

11. Electric machine according to claim 1, wherein two parts of the fastening clip, the parts being pivotable in relation to each other, are connected to each other via a joint.

12. Electric machine according to claim 1, wherein the fastening clip contains plastic, in particular polyphenylene sulfide.

13. Vehicle having an electric machine according to claim 1, which electric machine is provided for driving the vehicle.

14. Method for producing a thermally conductive coupling between a temperature sensor and a stator winding or a heat-conducting element of an electric machine, in particular an electric machine (according to claim 1, the heat-conducting element being thermally conductively connected to a stator winding, which method comprises the steps of
arranging the temperature sensor and the stator winding or the heat-conducting element in a fastening clip and
producing the thermally conductive coupling between the temperature sensor and the stator winding or the heat-conducting element by closing the fastening clip, wherein a latching connection of the fastening clip latches in and the fastening clip presses the temperature sensor against the stator winding or the heat-conducting element.

15. Electric machine according to claim 2, wherein a contact-pressure force generated by the fastening clip lies in a range of from 10 N≤F≤40 N.

16. Electric machine according to claim 2, wherein the fastening clip has a raised portion, which projects into a recess in the stator winding or the heat-conducting element, or the fastening clip has a recess, into which a raised portion of the stator winding or the heat-conducting element projects.

17. Electric machine according to claim 2, wherein the fastening clip has a guide for the heat-conducting element.

18. Electric machine according to claim 2, wherein the temperature sensor a) is loosely arranged in a recess in the fastening clip or b) is fastened to the fastening clip.

19. Electric machine according to claim 1, wherein a cable of the temperature sensor is guided through an opening in the fastening clip, wherein the opening is smaller than an extent of the temperature sensor or a heat-shrink tube mounted on the cable measured transversely to the longitudinal extent of the cable.

20. Electric machine according to claim 1, wherein an elastic element is arranged
between the temperature sensor and the fastening clip and/or
between the stator winding or the heat-conducting element and the fastening clip.
